(19) United States
(12) Patent Application Publication
(10) Pub. No.: US 2026/0221781 A1
(43) Pub. Date: Jul. 30, 2026

(54) AUXILIARY ELECTRICAL POWER SUPPLY SYSTEM

(71) Applicants: Robert G. Bos, Grand Haven, MI (US); Andrew J. Manning, Randolph, NJ (US)

(72) Inventors: Robert G. Bos, Grand Haven, MI (US); Andrew J. Manning, Randolph, NJ (US)

(73) Assignee: BAUER ENERGY SOLUTIONS, LLC, Grand Rapids, MI (US)

(21) Appl. No.: 19/460,707

(22) Filed: Jan. 27, 2026

Related U.S. Application Data
(60) Provisional application No. 63/750,576, filed on Jan. 28, 2025.

(51) Int. Cl. H02J 3/38; B60L 3/00; H02J 3/32

(52) U.S. Cl. CPC H02J 3/381; B60L 3/00; H02J 3/32

(57) ABSTRACT

An auxiliary electrical power supply system adapted for integration with a building electrical power system includes a local electrical power source, an energy storage battery, a charge controller interposed between the local electrical power source and the energy storage battery, a switch box selectively electrically coupled with the breaker panel, and an energy storage inverter electrically interposed between the energy storage battery and the switch box. A system controller controls the switch box to alternatively and selectively supply electrical energy from the external remote electrical power source and from the energy storage battery to the electrical circuits. The system provides supplemental electrical energy in addition to that supplied by the regional electric power source in ordinary operation and emergency electrical energy from the energy storage battery to the electrical circuits in the absence of electrical power supply from the external remote electric power source.

### CLAIM OF PRIORITY

The present application claims the priority benefits under the provisions of 35 U.S.C. § 119, basing said claim of priority on related U.S. Provisional Application No. 63/750,576 filed Jan. 28, 2025, which is incorporated in its entirety herein by reference.

### FIELD OF THE DISCLOSURE

The present disclosure generally relates to an auxiliary electrical power supply system for a building, particularly a residential building equipped with a central building electrical power distribution and regulation system having one or more electrical circuits originating from at least one breaker panel and an external remote electrical energy source, particularly supplied by a regional electric utility. The auxiliary electrical power supply device provides electrical energy in addition to that supplied by the regional electric utility in ordinary operation and emergency electrical energy from a stand-by battery to one or more electrical circuits in the absence of electrical power supply from the regional electric utility.

### BACKGROUND OF THE DISCLOSURE

Current government efforts to promote solar energy at the residential level have had limited success due to many factors. The primary approach has been to place solar panels on individual residences and connect them to the grid. These are installed by professional solar installers, generally involved anywhere from fifteen to thirty solar panels and cost $25,000 to $40,000 (some or all of which may be supplemented by a government loan) with a 15- to 20-year payback from the savings afforded in comparison to payments from the regional electric utility for the energy generated. However, there are several drawbacks with the foregoing features: (1) homeowners are often unhappy in that they do not have power when the grid goes down, even though they have solar panels (alternatively, battery storage to maintain the house in full operation like that of a generator may incur costs of nearly $100,000); (2) the regional electric utilities often do not prefer these systems it as the energy provided is very erratic (only when the sun is shining) and the regional electrical utility must balance this variable source, as well as having to pay/credit the homeowner; (3) such panels attached to the grid require inspection and approval by both the local government and the regional electric utility; (4) the approval process may drag out since the regional electric utility may not like the program, which may result in the solar installer having to carry the cost of installation for as long as six months, which is financially burdensome.

There also have been numerous attempts to sell solar backup systems on the internet and through advertising on television and elsewhere. However, the value proposition in this case may be poor. A $5000 solar/battery system will power only limited circuits of the house, compared to a $500 portable gasoline generator that will power the entire house. And in the case of a relatively reliable grid, using the back-up system for maybe six hours every two years does not offer an attractive return. Further, it does nothing to reduce the load on the grid.

A device to improve the performance and application of auxiliary electrical power supply systems was desired.

### SUMMARY OF THE DISCLOSURE

According to an aspect of the present disclosure, an auxiliary electrical power supply system is disclosed that is adapted for integration with an electrical power distribution and regulation system of a building having one or more electrical circuits originating from at least one breaker panel and an external remote electrical power source, such as a regional electric utility. The auxiliary electrical power supply system includes a local electrical power source, such as one or more solar panels, an energy storage battery, and a charge controller interposed between the local electrical power source and the energy storage battery through which the energy storage battery is supplied with electrical energy and by which a battery charge of the energy storage battery may be monitored and regulated. A switch box may be selectively electrically coupled with the breaker panel and an energy storage inverter may be electrically interposed between the energy storage battery and the switch box. A system controller may be operably coupled with the switch box, wherein the system controller is adapted to alternatively and selectively supply electrical energy from the external remote electrical power source and from the energy storage battery to one or more of the electrical circuits. The auxiliary electrical power supply system provides supplemental electrical energy in addition to that supplied by the external remote electrical power source in ordinary operation and the auxiliary electrical power supply system selectively provides emergency electrical energy from the energy storage battery to one or more electrical circuits in the absence of electrical power supply from the external remote electric power source.

These and other features, advantages, and objects of the present disclosure will be further understood and appreciated by those skilled in the art by reference to the following specification, claims, and appended drawings.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 is a schematic view of the auxiliary electrical power supply system adapted to provide supplemental electrical energy in addition to that supplied by a regional electric power source fully connected with the regional electric power according to the present disclosure; and

FIG. 2 is a schematic view of the auxiliary electrical power supply system in ordinary operation and further adapted to provide emergency electrical energy from a battery to one or more electrical circuits in the absence of electrical power supply from the external remote electric power source according to the present disclosure.

The components in the Figures are not necessarily to scale, emphasis instead being placed upon illustrating the principles described herein.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements may or may not be to scale and certain components may or may not be enlarged relative to the other components for purposes of emphasis and understanding.

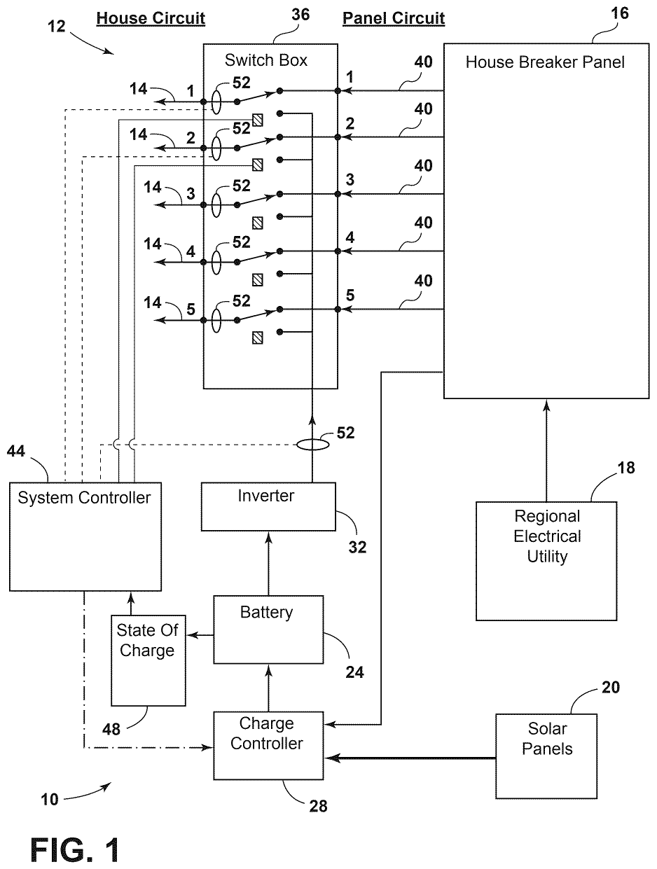

For purposes of description herein, the terms “upper,” “lower,” “right,” “left,” “inboard,” “outboard,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an auxiliary electrical power supply system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about10% of each other, such as within about 5% of each other, or within about 2% of each other.

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, the example embodiments are to cover all modifications, equivalents, and alternatives falling within the scope of the disclosure. Like numbers refer to like/similar elements throughout the detailed description.

It is understood that when an element is referred to as being “connected,” “coupled,” or “operably coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. Thus, for example, reference to “a component” includes embodiments having two or more such components unless the context clearly indicates otherwise.

It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be considered in the specific context this definition is given herein.

There are few, if any, systems that are of reasonable cost, that can be easily installed, provide continuous power and monetary savings with a good return on investment, and in addition provide load leveling for the power company.

The invention may be described as a modular hybrid solution. The auxiliary electrical power supply system is not intended to power an entire building, such as a residential house. Rather, it is intended to provide emergency backup while reducing the consumption from an external remote electrical power source, such as the grid operated by a regional electrical utility and in addition, provide load leveling for the regional electrical utility, minimizing consumption during peak periods and recharging the energy storage battery if needed during low or off-peak hours.

The auxiliary electrical power supply system 10 disclosed herein is intended to provide a decent return on investment, in addition to providing load leveling to benefit and gain the support of the regional electrical utilities 18. The auxiliary electrical power supply system 10 may be composed of a limited number of solar panels 20 (generally in the range of two to four 500 W panels), a moderate size energy storage battery 24 (between 2.5 and 10 kWh), an energy storage a charge controller 32, and a switch box 36 that may be readily installed by removing wires for each of the one or more electrical circuits 14 from the existing breaker panel 16 in the building circuit box, attaching them to the new switch box 36 and connecting a jumper 40 from the switch box 36 back to the breaker panel 16. The switch box 36 may have a variable and/or predetermined number of electrical circuits 14—it does not have to handle all the electrical circuits 14 in the breaker panel 16. As the auxiliary electrical power supply system 10 is modular, one switch box 36 may be put on each side of the breaker panel 16 (not shown). A system controller 44 is provided to operate and control the auxiliary electrical power supply system 10.

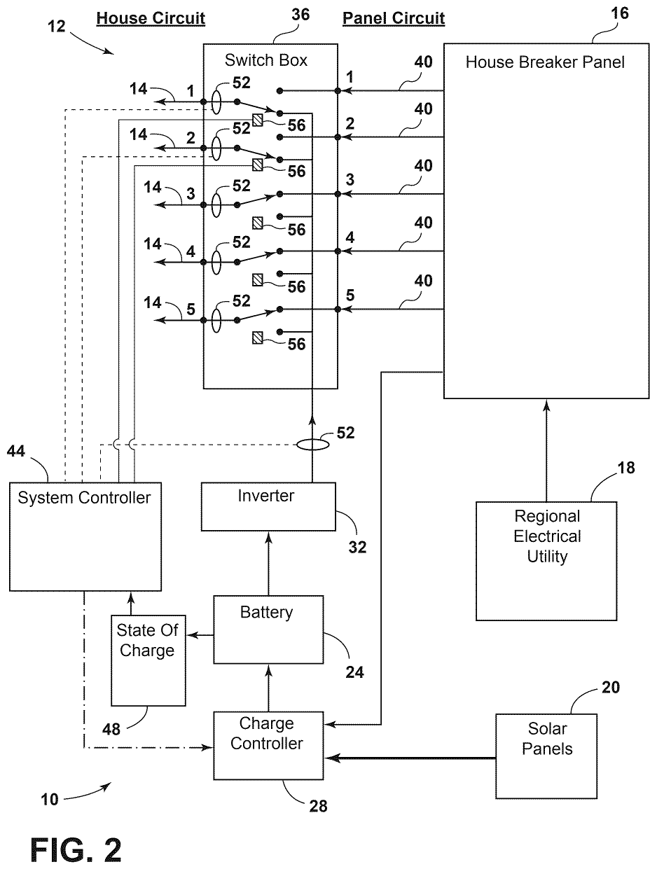

Referring generally to FIGS. 1 and 2, the invention herein disclosed addresses technical, financial and societal issues that have hindered greater implementation of solar energy. The auxiliary electrical power supply system 10 disclosed herein is adapted for integration with a central building electrical power distribution and regulation system 12 having one or more electrical circuits 14 originating from at least one breaker panel 16 and an external remote electrical power source. The auxiliary electrical power supply system 10 may provide supplemental electrical energy in addition to that supplied by the regional electric power source in ordinary operation and the auxiliary electrical power supply system 10 selectively provides emergency electrical energy from the energy storage battery 24 to one or more electrical circuits 14 in the absence of electrical power supply from the external remote electric power source. The auxiliary electrical power supply system 10 may comprise a local electrical power source (solar panels 20) and an energy storage battery 24, a charge controller 28, an energy storage inverter 32, a switch box 36, and system controller 44.

The external remote electrical power source may be regional electrical utility 18. The local electrical power source may include one or more solar panels 20, as described above. The charge controller 28 may be interposed between the local electrical power source 20 and the energy storage battery 24 through which the energy storage battery 24 is supplied with electrical energy and by which a battery charge of the energy storage battery 24 is monitored and regulated. The energy storage battery 24 may be capable of electrical energy output of 3000 to 10,000kWh, and the energy storage battery 24 may be equipped with a state of charge management system 48 to provides a signal to the system controller indicative of the energy storage battery 24 state of charge. It is contemplated that the energy storage battery 24 may comprise a solid-state energy storage battery 24, such as a lithium-ion energy storage battery 24, although this disclosure is not to limited to such.

Charge controller 28 may be in selective electrical communication with the external remote electrical power source through the breaker panel 16 and may be in selective electrical communication with the local electrical power source 20. As shown in the Figures, the charge controller 28 may provide direct current to the energy storage battery 24 and is adapted to directly charge the energy storage battery 24 and conditions the electrical power supplied by the solar panels 20. Charge controller 28 may be in signal communication with the system controller 44 and may be adapted to switch its supply of electrical power from between the breaker panel 16 and the local electrical power source 20 in response to a signal from the system controller 44. The charge controller 28 may be adapted to accept electrical power from the breaker panel 16 in response to a signal from the system controller 44 to recharge the energy storage battery 24. Finally, the charge controller 28 may be adapted to detect and signal a loss of electrical power from the breaker panel 16 to the system controller 44.

The switch box 36 may be selectively electrically coupled with the breaker panel 16. The switch box 36 may include one or more relays 56 adapted to switch the one or more electrical circuits 14 between electrical energy supplied by the external remote electrical power source (as shown in FIG. 1) and electrical energy supplied by the energy storage battery 24 (as shown in FIG. 2), whereby the system controller 44 is adapted to alternatively and selectively supply electrical energy from the external remote electrical power source and from the energy storage battery 24 to one or more of the electrical circuits 14, as discussed further below. The breaker panel 16 may include a plurality of electrical circuits 14, where each of the plurality of circuits 14 originates from an individual circuit breaker assigned to each of the plurality of circuits 14. The switch box 36 may include a plurality of relays 56, where each one of the pluralities of relays 56 is individually assigned to one of the circuits 14 of the breaker panel 16. Each of the plurality of relays 56 may be adapted to switch electrical energy between the external remote electric power source and the energy storage inverter 32. A current sensor 52 may be disposed electrically downstream of each of the plurality of relays 56 and adapted to provide current flow information to the system controller 44.

The number and capacity of the solar panels 20 may be such as to provide possibly 1,000 to 2,000 W of power in comparison to the 8,000 to 10,000 W needed to supply an entire house. The energy storage battery thus may provide two days of electrical energy supply of at least one critical electrical circuit, such the electrical circuit 14 servicing the kitchen with the refrigerator and lights and critical electronics.

The energy storage inverter 32 may be electrically interposed between the energy storage battery 24 and the switch box 36. The energy storage inverter 32 may be adapted to provide a 5,000 to 7,000 W peak output and may be adapted to convert electrical current from the energy storage battery 24 to the house circuit voltage. The energy storage inverter 32 should be of a power rating sufficient to handle starting currents of the compressor in the refrigerator, plus a microwave oven and even a small sump pump. It is contemplated that, as for installations in the United States, the circuit voltage is nominally 110-120V (60 Hz), although for certain applications such as submersible well pumps, 220-240V (60 Hz, split-phase) may be necessary and/or applicable.

The system controller 44 may be operably coupled with the switch box 36, wherein the system controller 44 is adapted to alternatively and selectively supply electrical energy from the external remote electrical power source and from the energy storage battery 24 to one or more of the electrical circuits 14. The system controller 44 may be adapted to connect all connected circuits 14 in the switch box 36 to the energy storage inverter 32 and energy storage battery 24 upon receipt of a signal from the charge controller 28 that the energy storage battery 24 has a state of charge at or greater than 20%. Alternatively, the system controller 44 may be adapted to connect all circuits 14 in switch box 36 to the breaker panel 16 upon receipt of a signal that the energy storage battery 24 has a state of charge at or lower than 20%.

The system controller 44 may be adapted to monitor the current from energy storage inverter 32 via a current sensor 52. The system controller 44 also may be adapted to monitor a step current change of the one or more electrical circuits 14 and, if the total of step current change of the one or more electrical circuits 14 exceeds a predetermined maximum current for the energy storage inverter 32, switches the electrical power supplied to the switch box 36 from the energy storage inverter 32 to the breaker panel 16. For example, in the event of an air conditioner actuation, a spike in the current upon actuation may exceed a predetermined maximum current of the energy storage inverter 32, which will return power supply to electrical circuit 14 experiencing the step increase in current to the regional electrical utility 18.

The system controller 44 also may be adapted to switch on the charge controller 28 electrically connected with and powered by the breaker panel 16 at a pre-determined time of day, such as early morning, when regional electrical utility 18 and grid demand is lowest. The system controller 44 may also be adapted to monitor the availability of electrical power from the breaker panel 16 and respond to a loss of electrical power by switching to electrical power from the energy storage battery 24 to pre-selected electrical circuits 14 of the one or more electrical circuits 14 to conserve the stored energy in the energy storage battery 24. Finally, the system controller 44 may be adapted to switch to an Emergency Status mode, wherein the energy storage battery 24 is maintained at a fully charged state in anticipation of an event which could result in a loss or reduction of power from the regional electrical utility 18. In the event of an expected power outage due to inclement weather or a brown-out due to excessive power demand on the grid, the system controller 44 may be adapted to monitor the regional electrical utility 18 for information relating to such events and adjust the configuration of the system accordingly.

The installation and location of the components of the present disclosure are relatively straightforward. The switch box of the auxiliary electrical power supply system may be installed on the house side of the main breaker panel. The wire out of a single breaker (or fuse) for a single electrical may be cut, and the wire then connected to the input of the switch box. The opposite wire to the house electrical circuit 14 may then be connected to the output of the switch box. This extremely simple installation does not involve regional electrical utility 18.

The electronics of the system controller 44 and charge controller 28 provide for charging (particularly avoiding overcharging) and discharging of the battery. The energy storage battery 24 supplies the energy to the house electrical circuit. When the sun is shining, the energy from the solar panels 20 is used to charge the energy storage battery 24, simultaneously while it is being discharged. If there is inadequate energy from solar panels 20, the energy storage battery 24 continues to supply the power to house electrical circuits 14. Thereafter, either during the night or at any time that the energy storage battery 24 reaches 20% state of charge (SOC), the energy storage battery 24 may be recharged from the grid maintained by the regional electric utility 18.

In operation, the solar panels 20 may be connected to the energy storage battery 24 through the charge controller 28 and thereby feed electrical energy to charge the energy storage battery 24 whenever the solar panels 20 generate power. Some or all of the electrical circuits 14 connected to the switch box 36 may at predetermined times be powered by the energy storage battery 24, as shown in FIG. 2. The system controller 44 monitors the instantaneous electrical current at each of the one or more electrical circuits 14 viz current sensors 48 disposed in the switch box 36, as well as the total current being supplied to the switch box 36 from the energy storage inverter 32 via current sensor 52. If an electrical load demanded by one or more of the electrical circuits 14 exceeds the capacity of the energy storage inverter 32, the relay 56 in the switch box 36 for the effected electrical circuit 14 is immediately switched back to the breaker panel 16, which remains available to provide overload protection.

For example, assume that the average single family detached home consumes approximately 29,000 Wh/day. The minimum “solar” hours (hours of solar generation per day) in Michigan is only four hours per day. Two 500-watt solar panels 20 may generate 4 kWh per day. That is 13-14% of the total energy consumed by the average house. This energy production matches well to a 5,000 Wh energy storage battery 24—cycling at up to 80% of capacity and leaving 20% in case of emergency. Four solar panels 20 with 10 kWh battery storage would provide over 25% of the electrical energy for the house. This electrical energy would not be required to be purchased from the regional electrical utility 18 and the consumer may enjoy overall savings of between 13-15% and 25% for their electrical consumption.

It is contemplated that the system controller 44 may implement an artificial intelligence (AI) control algorithm is a key element of the invention, for control of the switch box 36 and charge controller 28. One of the functions of the system controller 44 is providing control on the maintenance of the state of charge in the energy storage battery 24. If the state of charge in the energy storage battery 24 gets too low, for example, due to lack of sun providing solar energy, the system controller 44 may switch all of the electrical circuits 14 back to the grid, as shown in FIG. 1. Another part of managing the state of charge of the energy storage battery 24 is to “top-off” the energy storage battery 24 from the grid during minimum load hours, which are generally in the early morning, and which may provide lower per kW fees, as may be set in conjunction with the regional electrical utility 18.

Another function of the control algorithm of the system controller 44 is controlling the switching of the controlled electrical circuits 14 from the regional electrical utility 18 to the energy storage battery 24 and back again. As noted above, the system controller 44 monitors inrush current from the house loads on each of the electrical circuits 14, as well as the total current being supplied to the switch box 36. If any load exceeds the capacity of the energy storage inverter 32, the load and the electrical circuit 14 is immediately switched back to the house breaker panel 16, which still provides overload protection via the circuit breakers in the house breaker panel 16.

A third function of the control algorithm of the system controller 44 is to monitor the grid current and if the grid goes down, it will switch to emergency condition and power only those electrical circuits 14 designated as critical, which may include communication, security, refrigerator/freezer, water pumps, heat, and sump pumps, as well as other applications. It can also optimize the system controller 44 based on historical usage. Further, if an event is anticipated that may cause disruption of grid service, the auxiliary electrical power supply system 10 may be pre-set to ensure the energy storage battery 24 is at full charge. Finally, this functionality can communicate with the regional electrical utility 18 if rolling blackouts or brownouts are planned.

This disclosed auxiliary electrical power supply system 10 provides significant benefits to the regional electrical utility 18, as it provides continuous load leveling, helps reduce peak demand, and has no connection to the regional electrical utility 18. It benefits the homeowner by reducing their electric bills and providing emergency backup. It provides societal benefits in reducing demand on the regional electrical utility 18 and switching a meaningful portion of the energy consumed to solar and other alternative energy sources. It is also expected to be of reasonable cost for the average homeowner, require less room, and the installation of both the solar panels 20 and the switch box 36 is readily accomplished. In many states, the homeowner is allowed to do wiring on the homeowner's side of the meter or main breaker. In some cases, only an electrician's services will be required. This system may also receive the support of the regional electrical utilities 18, as it is beneficial to them and does not require their involvement.

In summary, the disclosed auxiliary electrical power supply system 10 provides limited investment requirements. It may provide a positive return on investment, as any solar energy generated reduces the homeowner's electric bill. It may be functionally and permanently installed on only one or more critical electrical circuits 14 of the building, such as those supplying building heating, refrigerators, freezers, well pumps, sump pumps, etc. It may be supplied by supplemental power from only one or more solar panels 20, which may be sufficient to supply power to the critical electric circuits 14, but not enough for the whole house, thus making the auxiliary electrical power supply system 10 more affordable.

The energy storage battery 24 may be configured to always supply electrical power to one or more electrical circuits 14 in normal operation, thus supplementing the electrical power from the not directly from the external remote electrical power source, such as the regional electrical utility 18, without any risk of feed-back electrical energy to the regional electrical utility 18. The energy storage battery 24 may be preferentially charged by solar panels 20, and the system controller 44 controls the charge the energy storage battery 24 from the solar panels 20 and may restrict recharging from the regional electrical utility 18 except at night, during off peak hours, to help level the electrical load on the regional electrical utility 18. It recharges at night, providing automatic, distributed load leveling to the regional electrical utility 18, which will improve the grid operation. This will benefit the regional electrical utility 18 significantly more than current standard solar installations, where they may have challenges in balancing the variable solar input. These features are believed likely to generate support from the regional electrical utilities 18.

In view of the foregoing features, the auxiliary electrical power supply system 10 disclosed herein is expected to pay for itself in energy savings (always on), automatically provide emergency back-up (of one or more critical circuits 14), does not require approval of the regional electrical utility 18, is simple to install (may be a “do it yourself” project is many States as the installation occurred on the owner's side of the meter), and costs significantly less than other systems that may cost $25,000 to $100,000.

It should be understood that variations, modifications, and improvements can be made on the aforementioned self-contained energy storage, distribution, and monitoring device 50 without departing from the concepts of the present disclosure, and further it is to be understood that such concepts are intended to be covered by the following claims unless these claims by their language expressly state otherwise.

What is claimed is:

1. An auxiliary electrical power supply system adapted for integration with an electrical power distribution and regulation system of a building having one or more electrical circuits originating from at least one breaker panel and an external remote electrical power source, the auxiliary electrical power supply system comprising:
a local electrical power source;
an energy storage battery;
a charge controller interposed between the local electrical power source and the energy storage battery through which the energy storage battery is supplied with electrical energy and by which a battery charge of the energy storage battery is monitored and regulated;
a switch box selectively electrically coupled with the breaker panel;
an energy storage inverter electrically interposed between the energy storage battery and the switch box; and
a system controller operably coupled with the switch box, wherein the system controller is adapted to alternatively and selectively supply electrical energy from the external remote electrical power source and from the energy storage battery to one or more of the electrical circuits;
wherein the auxiliary electrical power supply system provides supplemental electrical energy in addition to that supplied by the external remote electrical power source in ordinary operation and the auxiliary electrical power supply system selectively provides emergency electrical energy from the energy storage battery to one or more electrical circuits in an absence of electrical power supply from the external remote electric power source.

2. The auxiliary electrical power supply system of claim 1, wherein the external remote electrical power source comprises a regional electric utility.

3. The auxiliary electrical power supply system of claim 1, wherein the switch box comprises one or more relays adapted to switch one or more electrical circuits between electrical energy supplied by the external remote electrical power source and electrical energy supplied by the battery, whereby the system controller is adapted to alternatively and selectively supply electrical energy from the external remote electrical power source and from the energy storage battery to one or more of the electrical circuits.

4. The auxiliary electrical power supply system of claim 3, wherein the breaker panel comprises a plurality of electrical circuits and the switch box comprises a plurality of relays, and wherein each one of the pluralities of relays is individually assigned to one of the electrical circuits of the breaker panel.

5. The auxiliary electrical power supply system of claim 4, wherein each of the plurality of relays is adapted to switches electrical energy between the external remote electric power source and the energy storage inverter.

6. The auxiliary electrical power supply system of claim 4, wherein each of the plurality of electrical circuits originates from an individual circuit breaker assigned to each of the plurality of electrical circuits.

7. The auxiliary electrical power supply system of claim 4, wherein a current sensor is disposed electrically downstream of each of the plurality of relays and adapted to provide current flow information to the system controller.

8. The auxiliary electrical power supply system of claim 1, wherein the energy storage inverter is adapted to provide a 5000 to 7000 W peak output.

9. The auxiliary electrical power supply system of claim 1, wherein the energy storage inverter is adapted to convert electrical current from the energy storage battery to house circuit voltage.

10. The auxiliary electrical power supply system of claim 1, wherein the electrical circuit voltage is nominally 110-120V (60 Hz).

11. The auxiliary electrical power supply system of claim 1, wherein the electrical circuit voltage is nominally 220-240V (60 Hz, single phase or, split-phase).

12. The auxiliary electrical power supply system of claim 1, wherein the energy storage battery is capable of electrical energy output of 5000 to 10,000 kWh.

13. The auxiliary electrical power supply system of claim 1, wherein the energy storage battery is equipped with a state of charge management system to provides a signal to the system controller indicative of the energy storage battery state of charge.

14. The auxiliary electrical power supply system of claim 1, wherein the charge controller is in selective electrical communication with the external remote electrical power source through the at least one breaker panel and is in selective electrical communication with the local electrical power source.

15. The auxiliary electrical power supply system of claim 14, wherein the external remote electrical power source comprises a regional electrical utility and the local electrical power source comprises one or more solar panels.

16. The auxiliary electrical power supply system of claim 15, wherein the charge controller provides direct current to the energy storage battery.

17. The auxiliary electrical power supply system of claim 16, wherein the charge controller is adapted to directly charge the energy storage batter and conditions an electrical power supplied by the solar panels.

18. The auxiliary electrical power supply system of claim 14, wherein the charge controller is in signal communication with the system controller and is adapted to switch its supply of electrical power from between the at least one breaker panel and the local electrical power source in response to a signal from the system controller.

19. The auxiliary electrical power supply system of claim 14, wherein the charge controller is adapted to accept electrical power from the at least one breaker panel in response to a control signal from the system controller to recharge the energy storage battery.

20. The auxiliary electrical power supply system of claim 19, wherein the charge controller is adapted to signal loss of electrical power from the at least one breaker panel to the system controller.

21. The auxiliary electrical power supply system of claim 1, wherein the system controller is adapted to:
connect all circuits in the switch box to the energy storage inverter and energy storage battery upon receipt of a signal from the charge controller that the energy storage battery has a state of charge at or greater than 20%;
connect all of the one or more electrical circuits in the switch box to the at least one breaker panel upon receipt of a signal from the charge controller that the energy storage battery has a state of charge at or lower than 20%;
monitors the current from energy storage inverter;
monitors a step current change of the one or more electrical circuit and, if the total of step current change of the one or more electrical circuit exceeds a predetermined maximum inverter current that is less than existing current from the energy storage inverter, switches the electrical power supplied to the switch box from the energy storage inverter to the at least one breaker panel;
switches on the charge controller electrically connected with the breaker panel at a pre-determined time of day, such as early morning, when electrical utility and grid demand is lowest;
monitors availability of electrical power from the at least one breaker panel to the system controller and responds to the loss of electrical power from charge controller is adapted to signal loss of electrical power from the at least one breaker panel to the system controller by switching to electrical power from the energy storage battery to preselected electrical circuits of the one or more electrical circuits to conserve the stored energy in the energy storage battery; and
is adapted to assume an Emergency Status mode wherein the energy storage battery is maintained a fully charged state in anticipation of an event which could result in a loss or reduction of power from the external remote electrical power source.
